(19) United States
(12) Patent Application Publication
(10) Pub. No.: US 2026/0291786 A1
(43) Pub. Date: Sep. 24, 2026

(54) LOW-POWER WAKE-UP SIGNAL DESIGN

(71) Applicant: Nokia Technologies Oy, Espoo (FI)

(72) Inventors: Ganesh VENKATRAMAN, Oulu (FI); Jorma Johannes KAIKKONEN, Oulu (FI); Pasi Eino Tapio KINNUNEN, Oulu (FI); Alok SETHI, Oulu (FI)

(21) Appl. No.: 19/473,639

(22) PCT Filed: Apr. 29, 2024
(86) PCT No.: PCT/IB2024/054158

§ 371 Date: Oct. 8, 2025

Related U.S. Application Data
(60) Provisional application No. 63/464,466, filed on May 5, 2023.

(51) Int. Cl. H04L 25/49; H04L 5/00; H04L 27/10; H04L 27/26; H04W 52/02

(52) U.S. Cl. CPC H04L 25/4902; H04L 5/0007; H04L 27/10; H04L 27/2602; H04W 52/0235

(57) ABSTRACT

Systems, methods, apparatuses, and computer program products for low-power wake-up signal design. A method may include receiving an orthogonal frequency division multiplexing symbol of a low-power wake-up signal from a network element. The method may also include determining, based on the low-power wake-up signal, an amplitude threshold. The method may further include determining, based on the orthogonal frequency division multiplexing symbol of the low-power wake-up signal, a first part of information bits. Further, the method may include determining, based on the threshold, a location of a signal pulse of the low-power wake-up signal within the orthogonal frequency division multiplexing symbol. In addition, the method may include estimating a second part of information bits based on the location of the signal pulse.

### FIELD

Some example embodiments may generally relate to mobile or wireless telecommunication systems, such as Long Term Evolution (LTE) or fifth generation (5G) new radio (NR) access technology, or 5G beyond, or other communications systems. For example, certain example embodiments may relate to apparatuses, systems, and/or methods for low-power wake-up signal (LP-WUS) design.

### BACKGROUND

Examples of mobile or wireless telecommunication systems may include the Universal Mobile Telecommunications System (UMTS) Terrestrial Radio Access Network (UTRAN), LTE Evolved UTRAN (E-UTRAN), LTE-Advanced (LTE-A), MulteFire, LTE-A Pro, fifth generation (5G) radio access technology or NR access technology, and/or 5G-Advanced. 5G wireless systems refer to the next generation (NG) of radio systems and network architecture. 5G network technology is mostly based on NR technology, but the 5G (or NG) network can also build on E-UTRAN radio. It is estimated that NR may provide bitrates on the order of 10-20 Gbit/s or higher, and may support at least enhanced mobile broadband (eMBB) and ultra-reliable low-latency communication (URLLC) as well as massive machine-type communication (mMTC). NR is expected to deliver extreme broadband and ultra-robust, low-latency connectivity and massive networking to support the IoT.

### SUMMARY

Some example embodiments may be directed to a method. The method may include receiving an orthogonal frequency division multiplexing symbol of a low-power wake-up signal from a network element. The method may also include determining, based on the low-power wake-up signal, an amplitude threshold. The method may further include determining, based on the orthogonal frequency division multiplexing symbol of the low-power wake-up signal, a first part of information bits. In addition, the method may include determining, based on the threshold, a location of a signal pulse of the low-power wake-up signal within the orthogonal frequency division multiplexing symbol. Further, the method may include estimating a second part of information bits based on the location of the signal pulse.

Other example embodiments may be directed to an apparatus. The apparatus may include at least one processor and at least one memory storing instructions. The instructions, when executed by the at least one processor, cause the apparatus at least to receive an orthogonal frequency division multiplexing symbol of a low-power wake-up signal from a network element. The apparatus may also be caused to determine, based on the low-power wake-up signal, an amplitude threshold. The apparatus may further be caused to determine, based on the orthogonal frequency division multiplexing symbol of the low-power wake-up signal, a first part of information bits. In addition, the apparatus may be caused to determine, based on the threshold, a location of a signal pulse of the low-power wake-up signal within the orthogonal frequency division multiplexing symbol. Further, the apparatus may be caused to estimate a second part of information bits based on the location of the signal pulse.

Other example embodiments may be directed to an apparatus. The apparatus may include means for receiving an orthogonal frequency division multiplexing symbol of a low-power wake-up signal from a network element. The apparatus may also include means for determining, based on the low-power wake-up signal, an amplitude threshold. The apparatus may further include means for determining, based on the orthogonal frequency division multiplexing symbol of the low-power wake-up signal, a first part of information bits. In addition, the apparatus may include means for determining, based on the threshold, a location of a signal pulse of the low-power wake-up signal within the orthogonal frequency division multiplexing symbol. Further, the apparatus may include means for estimating a second part of information bits based on the location of the signal pulse.

In accordance with other example embodiments, a non-transitory computer readable medium may be encoded with instructions that may, when executed in hardware, perform a method. The method may include receiving an orthogonal frequency division multiplexing symbol of a low-power wake-up signal from a network element. The method may also include determining, based on the low-power wake-up signal, an amplitude threshold. The method may further include determining, based on the orthogonal frequency division multiplexing symbol of the low-power wake-up signal, a first part of information bits. In addition, the method may include determining, based on the threshold, a location of a signal pulse of the low-power wake-up signal within the orthogonal frequency division multiplexing symbol. Further, the method may include estimating a second part of information bits based on the location of the signal pulse.

Other example embodiments may be directed to a computer program product that performs a method. The method may include receiving an orthogonal frequency division multiplexing symbol of a low-power wake-up signal from a network element. The method may also include determining, based on the low-power wake-up signal, an amplitude threshold. The method may further include determining, based on the orthogonal frequency division multiplexing symbol of the low-power wake-up signal, a first part of information bits. In addition, the method may include determining, based on the threshold, a location of a signal pulse of the low-power wake-up signal within the orthogonal frequency division multiplexing symbol. Further, the method may include estimating a second part of information bits based on the location of the signal pulse.

Other example embodiments may be directed to an apparatus that may include circuitry configured to receive an orthogonal frequency division multiplexing symbol of a low-power wake-up signal from a network element. The apparatus may also include circuitry configured to determine, based on the low-power wake-up signal, an amplitude threshold. The apparatus may further include circuitry configured to determine, based on the orthogonal frequency division multiplexing symbol of the low-power wake-up signal, a first part of information bits. In addition, the apparatus may include circuitry configured to determine, based on the threshold, a location of a signal pulse of the low-power wake-up signal within the orthogonal frequency division multiplexing symbol. Further, the apparatus may include circuitry configured to estimate a second part of information bits based on the location of the signal pulse.

Some example embodiments may be directed to a method. The method may include segmenting a payload of bits of a low-power wake-up signal into a plurality of sets. The method may also include encoding a first set of the plurality of sets. The method may further include assigning the encoded bits of the first set of the payload of bits to subcarriers with subcarrier spacing of the low-power wake-up signal. In addition, the method may include applying phase ramp to the assigned subcarriers based on a second set of the plurality of sets.

Other example embodiments may be directed to an apparatus. The apparatus may include at least one processor and at least one memory storing instructions. The instructions, when executed by the at least one processor, cause the apparatus at least to segment a payload of bits of a low-power wake-up signal into a plurality of sets. The apparatus may also be caused to encode a first set of the plurality of sets. The apparatus may further be caused to assign the encoded bits of the first set of the payload of bits to subcarriers with subcarrier spacing of the low-power wake-up signal. In addition, the apparatus may be caused to apply phase ramp to the assigned subcarriers based on a second set of the plurality of sets.

Other example embodiments may be directed to an apparatus. The apparatus may include means for segmenting a payload of bits of a low-power wake-up signal into a plurality of sets. The apparatus may also include means for encoding a first set of the plurality of sets. The apparatus may further include means for assigning the encoded bits of the first set of the payload of bits to subcarriers with subcarrier spacing of the low-power wake-up signal. In addition, the apparatus may include means for applying phase ramp to the assigned subcarriers based on a second set of the plurality of sets.

In accordance with other example embodiments, a non-transitory computer readable medium may be encoded with instructions that may, when executed in hardware, perform a method. The method may include segmenting a payload of bits of a low-power wake-up signal into a plurality of sets. The method may also include encoding a first set of the plurality of sets. The method may further include assigning the encoded bits of the first set of the payload of bits to subcarriers with subcarrier spacing of the low-power wake-up signal. In addition, the method may include applying phase ramp to the assigned subcarriers based on a second set of the plurality of sets.

Other example embodiments may be directed to a computer program product that performs a method. The method may include segmenting a payload of bits of a low-power wake-up signal into a plurality of sets. The method may also include encoding a first set of the plurality of sets. The method may further include assigning the encoded bits of the first set of the payload of bits to subcarriers with subcarrier spacing of the low-power wake-up signal. In addition, the method may include applying phase ramp to the assigned subcarriers based on a second set of the plurality of sets.

Other example embodiments may be directed to an apparatus that may include circuitry configured to segment a payload of bits of a low-power wake-up signal into a plurality of sets. The apparatus may also include circuitry configured to encode a first set of the plurality of sets. The apparatus may also include circuitry configured to assign the encoded bits of the first set of the payload of bits to subcarriers with subcarrier spacing of the low-power wake-up signal. In addition, the apparatus may include circuitry configured to apply phase ramp to the assigned subcarriers based on a second set of the plurality of sets.

### BRIEF DESCRIPTION OF THE DRAWINGS

For proper understanding of example embodiments, reference should be made to the accompanying drawings, wherein:

FIG. 1(a) illustrates an example of on-off keying (OOK) modulation with additional phase ramp for each symbol, according to certain example embodiments.

FIG. 1(b) illustrates another example of OOK modulation with additional phase ramp for each symbol, according to certain example embodiments.

FIG. 2(a) illustrates an example frequency shift keying (FSK) modulation with phase ramp according to certain example embodiments.

FIG. 2(b) illustrates a spectrum of locations of low-power wake-up signal (LP-WUS) pulses in each symbol.

FIG. 2(c) illustrates a further example of FSK modulation, according to certain example embodiments.

FIG. 3 illustrates an example flow diagram of a receiver procedure, according to certain example embodiments.

FIG. 4 illustrates an example flow diagram of a transmit procedure, according to certain example embodiments.

FIG. 5 illustrates an example flow diagram of a method, according to certain example embodiments.

FIG. 6 illustrates an example flow diagram of another method, according to certain example embodiments.

FIG. 7 illustrates a set of apparatuses, according to certain example embodiments.

### DETAILED DESCRIPTION

It will be readily understood that the components of certain example embodiments, as generally described and illustrated in the figures herein, may be arranged and designed in a wide variety of different configurations. The following is a detailed description of some example embodiments of systems, methods, apparatuses, and computer program products for low-power wake-up signal (LP-WUS) design. For example, certain example embodiments may be directed to LP-WUS design using 2D modulation to map information bits.

The features, structures, or characteristics of example embodiments described throughout this specification may be combined in any suitable manner in one or more example embodiments. For example, the usage of the phrases “certain embodiments,” “an example embodiment,” “some embodiments,” or other similar language, throughout this specification refers to the fact that a particular feature, structure, or characteristic described in connection with an embodiment may be included in at least one embodiment. Thus, appearances of the phrases “in certain embodiments,” “an example embodiment,” “in some embodiments,” “in other embodiments,” or other similar language, throughout this specification do not necessarily refer to the same group of embodiments, and the described features, structures, or characteristics may be combined in any suitable manner in one or more example embodiments. Further, the terms “base station”, “cell”, “node”, “gNB”, “network” or other similar language throughout this specification may be used interchangeably.

As used herein, “at least one of the following: <a list of two or more elements>” and “at least one of <a list of two or more elements>” and similar wording, where the list of two or more elements are joined by “and” or “or,” mean at least any one of the elements, or at least any two or more of the elements, or at least all the elements.

Various methods exist aiming to reduce power consumption of various types of user equipment (UE) including, for example, sensors, actuators, and wearables, that require a long battery life. Methods such as extended discontinuous reception (eDRX) may extend the period that the UE sleeps between waking up to monitoring for paging. However, eDRX may not be suitable for latency sensitive UEs that require reduced power consumption because it may lead to long communication delays.

The wake-up signal (WUS) principle, if configured appropriately, enables a network to trigger a UE to wake-up exactly when needed in an event-driven manner. This may be accomplished by transmitting a special WUS that is monitored by a dedicated low-power WUS receiver of the UE, thereby avoiding the delays associated with eDRX. When a UE receives the WUS, the logically separated WUS receiver may wake-up the main transceiver and normal communication can start.

The WUS receiver is expected to consume significantly less power compared to the main new radio (NR) transceiver. This may be accomplished by using a simple (WUS) signal that can be detected using dedicated hardware optimized for low power consumption. There may be various use cases for the WUS including, for example, reducing power consumption for idle/inactive mode UEs monitoring paging, reducing power consumption for connected mode UE physical downlink control channel (PDCCH) monitoring, providing cell specific synchronization support, providing radio resource management (RRM) measurement support, and providing lower-power wake-up signal (LP-WUS) threshold detection support.

In the case of on-off keying (OOK), with one bit per symbol transmission, the energy available over the LP-WUS bandwidth (BW) for a given symbol may determine the presence or absence of a bit. When a bit stream is Manchester encoded, each bit is either encoded with [0,1] or [1,0] to ensure transition for each information symbol. Similarly, in frequency shift keying (FSK) schemes, the information is encoded in the frequency domain. Thus, the available information bits are encoded only on dimension depending on the modulation scheme. Accordingly, to address these drawbacks, certain example embodiments described herein may utilize two dimensions (2D) to encode the raw bits and improve spectral efficiency without compromising performance. The second dimension may be based on the location of the pulse within a symbol duration as in pulse position modulation (PPM).

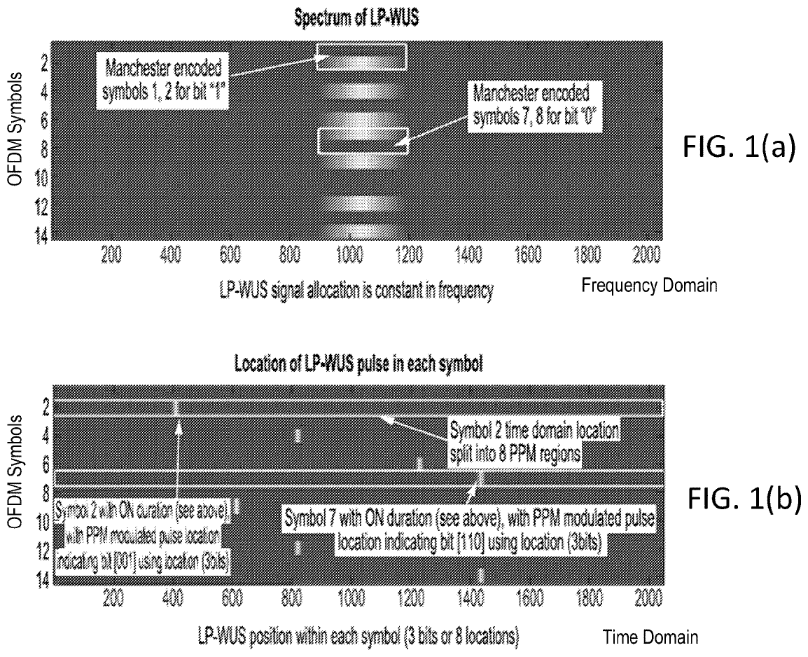

FIG. 1(a) illustrates an example of OOK modulation, according to certain example embodiments. In particular, FIG. 1(a) illustrates an example spectrum of LP-WUS. FIG. 1(b) illustrates the effect of applying phase ramp to the OOK modulation in FIG. 1(a), according to certain example embodiments. In particular, FIG. 1(b) illustrates an example location of LP-WUS pulse in each symbol. The examples illustrated in FIGS. 1(a) and 1(b) correspond to an OOK scheme that does not include discrete Fourier transform (DFT) spreading. As illustrated in FIGS. 1(a) and 1(b), the x-axis divide the frequency and time, respectively, into 2048 points. Thus, each symbol includes 2048 samples (within which PPM modulation is used). When FFT is performed using the 2048 samples from the time domain, the observation illustrated in FIG. 1(a) is obtained. As illustrated in FIGS. 1(a) and 1(b), to transmit a bit such as, for example, 0, it may be encoded as [0,1] using Manchester encoding, which may then be transmitted over two cyclic prefix orthogonal frequency-division multiplexing (CP-OFDM) symbols. Using higher subcarrier spacing (SCS) compared to the NR signal, more information bits may be transmitted with the equivalent CP-OFDM symbol of the NR signal. For example, if the NR signal uses SCS of 15 KHz and LP-WUS uses SCS of 120 KHz, then equivalent to a single NR symbol, the LP-WUS can transmit 4 information bits or 8 Manchester encoded bits. Depending on the BW of the LP-WUS transmission, the pulse width in the time domain may vary (i.e., pulse width may be small if the LP-WUS BW is large), thereby following an inverse relation.

Due to the narrowness of the pulse in the time domain, the LP-WUS pulse may be positioned within a respective CP-OFDM symbol by providing a phase ramp in the frequency domain. The position of the LP-WUS pulse within the respective CP-OFDM symbol may then be used as a PPM, which can then be decoded to provide additional information to the UEs. As illustrated in FIG. 1(a), the LP-WUS may be transmitted at a given/fixed frequency location of the spectrum that is constant across all symbols. However, as illustrated in FIG. 1(b), due to the varying phase ramps (introduced by modulation), the position of the LP-WUS pulse within each CP-OFDM symbol of the LP-WUS transmission may be controlled to provide different position information. Thus, if the position of the LP-WUS pulse is quantized as 8 discrete segments, then by using 8 different phase shifts, the pulse may be positioned in the time domain within each symbol of the CP-OFDM to provide 3 bits of information. As illustrated in FIG. 1(b), 8 arbitrary locations in each symbol instance are used, and only one pulse is observed in each symbol. However, the location of the pulse within each CP-OFDM symbol may be altered by phase ramp. In other example embodiments, DFT spread OOK transmission may be used to utilize the frequency domain by providing each pulse with a discrete tone to place the pulse in the frequency domain at discrete locations. Both FSK and OOK are possible for 2D modulation encoding. Accordingly, by utilizing this 2D approach illustrated in FIGS. 1(a) and 1(b), it may be possible to increase the overall information provided to the UEs.

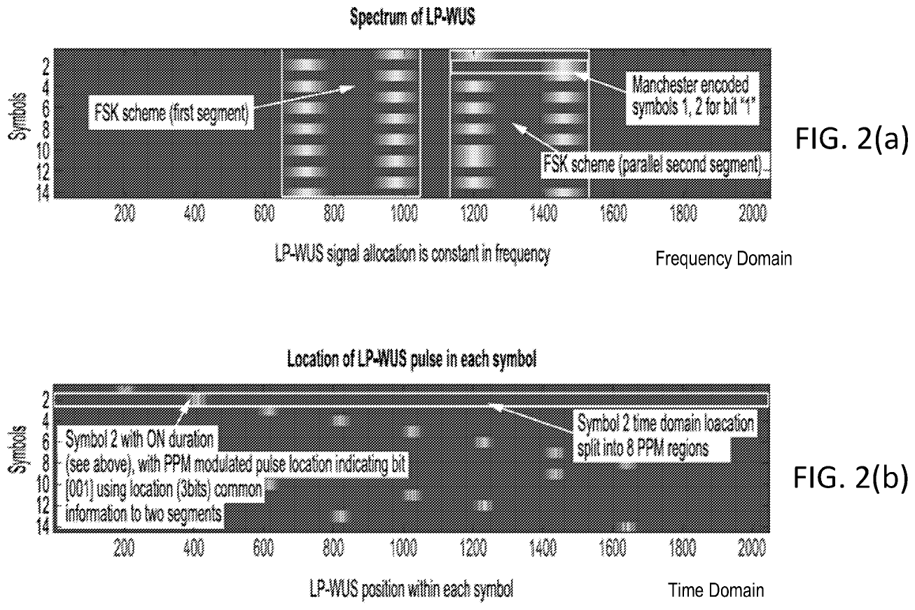

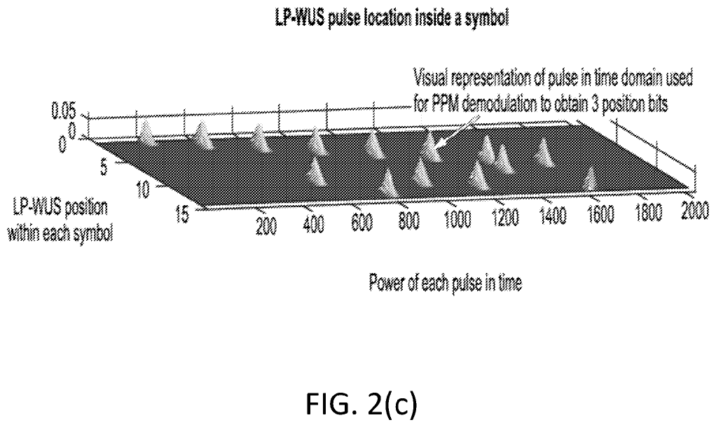

FIG. 2(a) illustrates an example FSK modulation with phase ramp according to certain example embodiments. For example, FIG. 2(a) illustrates a spectrum of LP-WUS under FSK modulation with a phase ramp. FIG. 2(b) illustrates another example of FSK modulation, according to certain example embodiments. For example, FIG. 2(b) illustrates a spectrum of locations of LP-WUS pulses in each symbol. FIG. 2(c) illustrates a further example of FSK modulation, according to certain example embodiments. For example, FIG. 2(c) illustrates LP-WUS pulse locations inside a symbol.

As illustrated in FIGS. 2(a)-2(c), unlike OOK where the entire BW may be used for LP-WUS transmissions, FSK may use a pair of frequency regions to encode information bits. FIGS. 2(a)-2(c) provides an example where N=2 segments carrying LP-WUS information are transmitted simultaneously. However, in other example embodiments, N may not be limited to 2, and may include more or less than 2. With regard to the examples illustrated in FIGS. 2(a)-2(c), there are 2 frequency segments each containing a pair of frequency regions. In one option, N segments may be monitored by separate groups of UEs (i.e., each UE group may have its respective segment containing a pair of frequency regions, and FSK type signaling may be performed). In another option, N segments may be monitored by all UEs. In certain example embodiments, the width of the pulse may depend on the width of each FSK segment. Thus, by applying phase ramp on the frequency domain segments containing an ON region, it may be possible to position the pulse at a distinct location, which can then provide additional degrees of information to the low-power wake-up radios (LRs). The additional information may be used, for example, to differentiate between different WUS entities from each other because each WUS entity may track a given unique sequency pattern. Note that in FSK modulation, the two Manchester encoded bits of one information bit are placed in the pair of frequency regions, respectively, as illustrated in the example of FIG. 2(a).

In the example embodiment described in FIGS. 2(a)-2(c), although two parallel streams of LP-WUS bits may be used for an FSK-based transmission, a single phase shift may be applied jointly over the time domain samples. By doing so, the received signal pulse location within the CP-OFDM symbol may be unambiguous, and may be used to provide common information to both sessions. Thus, it may be possible to control the information transmitted for all segments in addition to segment specific information via FSK modulation, as illustrated in FIGS. 2(a)-2(c). Furthermore, in the FSK scheme, common signaling across multiple FSK segments may be transmitted via PPM since the pulse location may be common for all time domain regions of the FSK. Accordingly, the 2D modulation scheme using either OOK or FSK based modulation together with PPM based encoding may provide additional information to the UEs. This may be accomplished even though for PPM-based schemes, it may be assumed in certain example embodiments that LRs may be synchronized to the gNBs via either dedicated LP-WUS synchronization signals or with preambles. In certain example embodiments, the modulation scheme described herein may be applied to an LP-WUS payload.

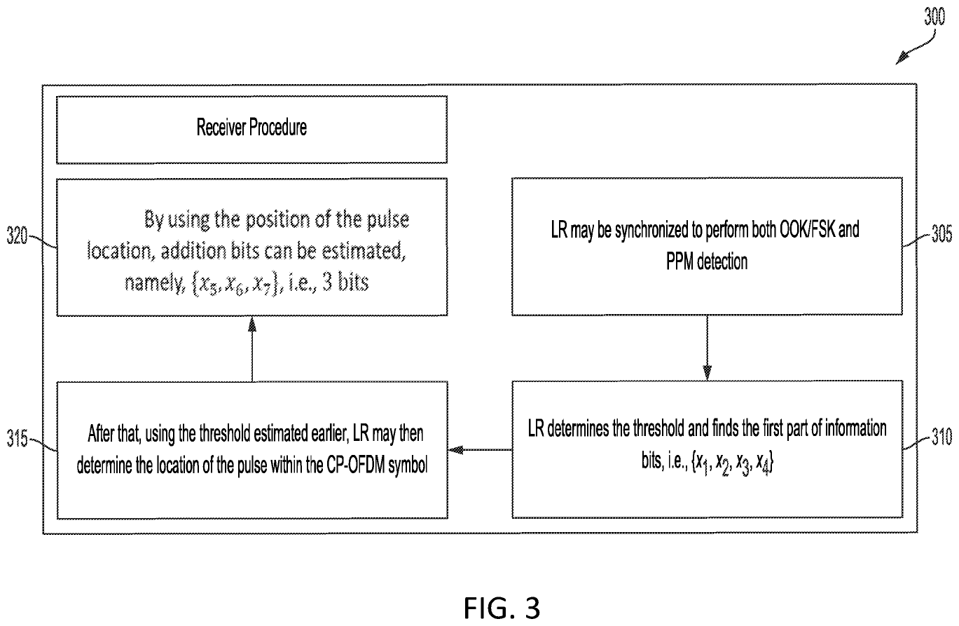

FIG. 3 illustrates an example flow diagram of a receiver procedure 300, according to certain example embodiments. For instance, the receiver procedure 300 illustrated in FIG. 3 may correspond to functionalities of a UE, which may be an LR. At operation 305, the LR may be synchronized to the network (e.g., gNB) to perform both OOK or FSK, and PPM detection. At operation 310, the LR may determine a threshold, and find a first part of information bits such as, for example, {x₁, x₂, x₃, x₄}. For an initial detection of the first part, the average energy over all the Manchester encoded bits may be used as a threshold to determine the presence of the LP-WUS signal. In certain example embodiments, the first part may be detected by determining the Manchester encoded bit containing the energy that crosses the threshold previously evaluated. If the encoding is 0=>[0, 1] or 1=>[1, 0], then for example, decoding of information bit x₁ depends on which Manchester encoded bit has a higher energy. Upon identifying the encoded bit with higher energy, the information bit {x₁, x₂, x₃, x₄} may be evaluated.

At operation 315, after the LR determines the threshold and finds the first part of the information bits, the LR may use the threshold to determine a location of an LP-WUS pulse within a CP-OFDM symbol. At operation 320, by using the pulse location, the LR may estimate additional bits such as, for example, if it is agreed to use 8 regions within a CP-OFDM symbol, the additional bit {x₅, x₆, x₇} in the second dimension can be identified.

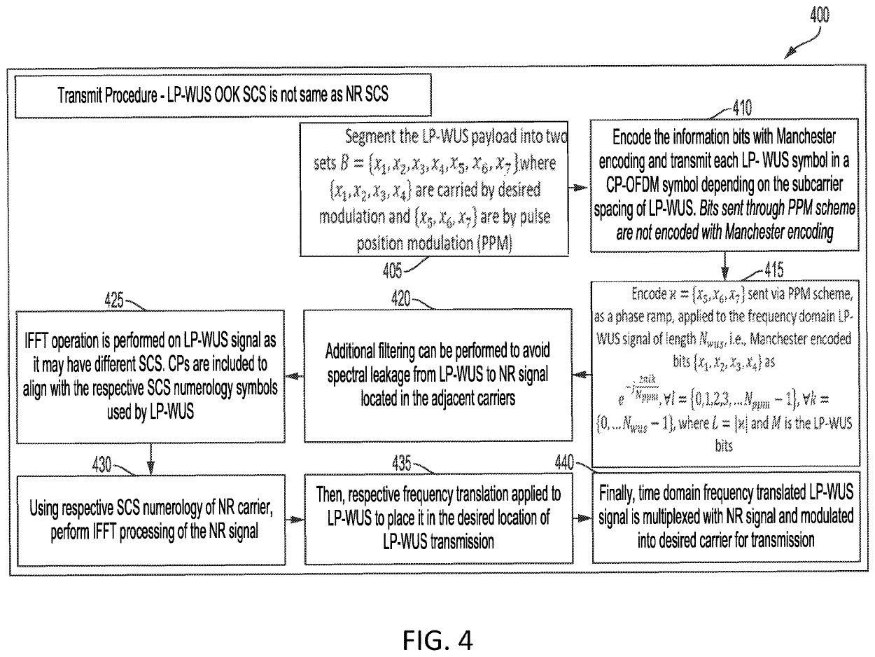

FIG. 4 illustrates an example flow diagram of a transmit procedure 400, according to certain example embodiments. As illustrated in FIG. 4, the transmit procedure 400 may be an implementation of the OOK-based or FSK-based LP-WUS with mixed numerology SCSs, and may correspond to functionalities of the network (e.g., gNB). In the transmit procedure 400, a transmitter of the gNB may build a transmitted signal starting from a WUS sequence, and allocate the signal into frequency domain resources per WUS symbol using WUS SCS.

As illustrated in FIG. 4, at operation 405, the network may segment an LP-WUS payload, e.g., B={x₁, x₂, x₃, x₄, x₅, x₆, x₇} into two sets, where {x₁, x₂, x₃, x₄} are carried by a predefined modulation (e.g., with OOK or FSK), and {x₅, x₆, x₇} may be carried by PPM. At operation 410, the information bits may be encoded with Manchester encoding. In some example embodiments, the bits sent through PPM may not be encoded with Manchester encoding. At operation 415, PPM bits κ={x₅, x₆, x₇} may be encoded as a phase ramp and applied to the frequency domain LP-WUS. For example, for Manchester encoded bit 1, a phase ramp depending on the PPM bits κ is applied as

$${e}^{- j \frac{2 π k l}{{N}_{p p m}}} ,$$

∀l={0,1,2, . . . . N_{wus}−1} and k={0, . . . , Nₚₚₘ−1}, where L=|κ|, Nₚₚₘ=2^{L} and N_{wus}denotes the total number of sub-carriers within LP-WUS BW. In this example, L=3, and Nₚₚₘ=8. At operation 420, additional filtering may be performed on the LP-WUS to avoid spectral leakage from the LP-WUS signal to NR signal located in adjacent carriers (e.g., arbitrary SCS considered in the adjacent NR signal, which may differ from LP-WUS). At operation 425, the IFFT operation may be performed on the LP-WUS signal as it may have different SCS than that of the NR signal. CPs (based on the OFDM generation) may be included to align with the respective SCS numerology symbols used by the LP-WUS. That is, at operation 425, the LP-WUS signal may be transformed into the time domain with IFFT operation. Note that if there are more than one frequency segments configured for FSK as illustrated in the example of FIG. 2, the multiple segments may be multiplexed in frequency domain for parallel FSK transmissions before IFFT operation at 425.

At operation 430, the respective SCS numerology of the NR carrier may be used in IFFT processing of the NR signal. At operation 435, respective translation may be applied to the LP-WUS to place it in the desired location of the LP-WUS transmission. For instance, the WUS signal may be transformed back to the frequency domain and allocated into the NR main carrier subcarriers with a main SCS over the WUS allocated frequency resources. At operation 440, the time domain LP-WUS signal may be multiplexed with the NR signal and modulated into a desired carrier for transmission.

In certain example embodiments, the additional information that may be provided to the UE may include identification of the WUS entity to which the message is targeted (e.g., certain UE(s) monitor/act upon only certain phase ramps/pulse locations). The information may also include providing further segmentation between UE groups, assisting the UE to reduce the unnecessary paging wake-up probability. The information may further include providing further information for the target paging occasion (PO) (to be monitored), or to other UE procedures related to an LP-WUS triggered action. Furthermore, the additional information may include enabling differentiation of LP-WUS messages or message interpretation (based on pulse location). Additionally, the information may include differentiation of LP-WUS messages from different sources (e.g., cells transmission reception points (TRPs), and/or beams). In certain example embodiments, the additional information may not be limited to the examples described above, and the additional information may include one or a combination of one or more types of information described above.

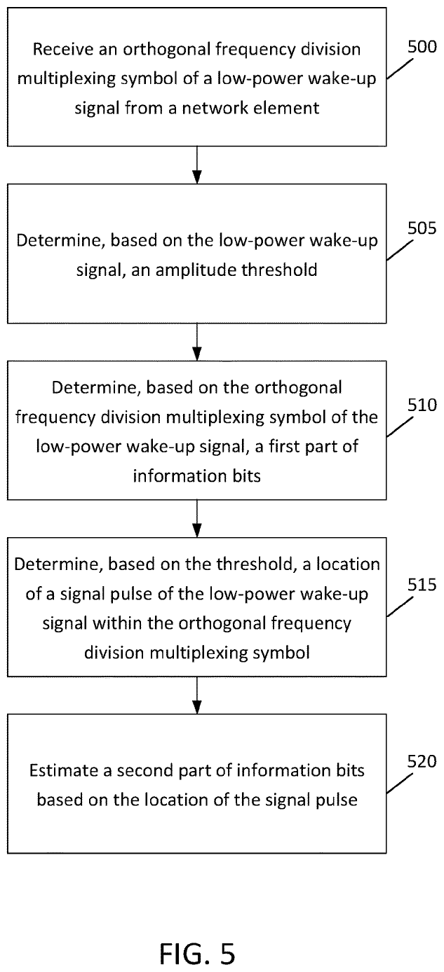

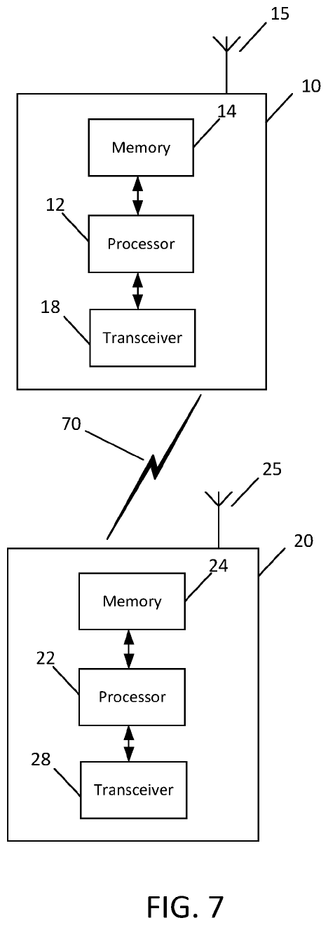

FIG. 5 illustrates an example flow diagram of a method, according to certain example embodiments. In an example embodiment, the method of FIG. 5 may be performed by a network entity, or a group of multiple network elements in a 3GPP system, such as LTE or 5G-NR. For instance, in an example embodiment, the method of FIG. 5 may be performed by an LR (i.e., UE) similar to one of apparatuses 10 or 20 illustrated in FIG. 7.

According to certain example embodiments, the method of FIG. 5 may include, at 500, receiving an orthogonal frequency division multiplexing symbol of a low-power wake-up signal from a network element. The method may also include, at 505, determining, based on the low-power wake-up signal, an amplitude threshold. The method may further include, at 510, determining, based on the orthogonal frequency division multiplexing symbol of the low-power wake-up signal, a first part of information bits. In addition, the method may include, at 515, determining, based on the threshold, a location of a signal pulse of the low-power wake-up signal within the orthogonal frequency division multiplexing symbol. Further, the method may include, at 520, estimating a second part of information bits based on the location of the signal pulse.

According to certain example embodiments, the method may further include performing synchronization with the network element in order to perform on-off keying or frequency shift keying, and pulse position modulation detection. According to some example embodiments, the signal pulse may be a low-power wake-up signal pulse. According to other example embodiments, the low-power wake-up signal may be received at a frequency location in a spectrum that is constant across all symbols. According to further example embodiments, the signal pulse may include a width in a time domain that varies based on a bandwidth of the low-power wake-up signal transmission.

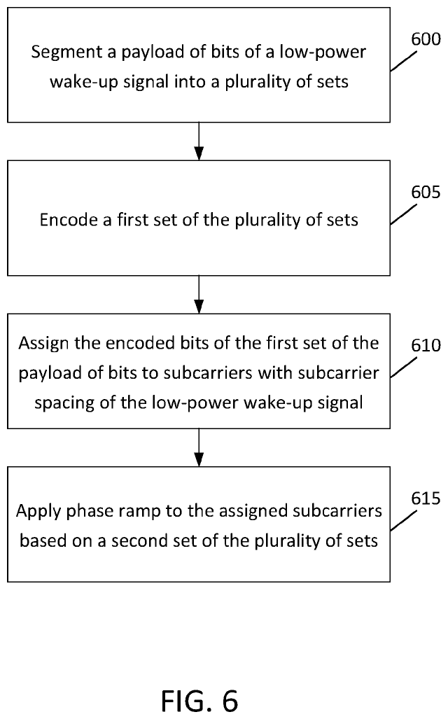

FIG. 6 illustrates an example flow diagram of another method, according to certain example embodiments. In an example embodiment, the method of FIG. 6 may be performed by a network entity, or a group of multiple network elements in a 3GPP system, such as LTE or 5G-NR. For instance, in an example embodiment, the method of FIG. 6 may be performed by the network (e.g., gNB) similar to one of apparatuses 10 or 20 illustrated in FIG. 7.

According to certain example embodiments, the method of FIG. 6 may include, at 600, segmenting a payload of bits of a low-power wake-up signal into a plurality of sets. The method may also include at 605, encoding a first set of the plurality of sets. The method may further include at 610, assigning the encoded bits of the first set of the payload of bits to subcarriers with subcarrier spacing of the low-power wake-up signal. In addition, the method may include, at 615, applying phase ramp to the assigned subcarriers based on a second set of the plurality of sets.

According to certain example embodiments, the first set of the plurality of sets may be carried by a predefined modulation, and a second set of the plurality of sets may be carried by a pulse position modulation. According to some example embodiments, the method may also include placing the low-power wake-up signal in a desired frequency location of the orthogonal frequency division multiplexing symbol. According to other example embodiments, the method may further include filtering the low-power wake-up signal.

In certain example embodiments, the orthogonal frequency division multiplexing symbol may carry information including at least one of identification of a wake-up signal entity, information on further segmentation between user equipment groups, information for a target paging occasion to be monitored, or for a user equipment procedure related to a low-power wake-up signal triggered action, information enabling differentiation of low-power wake-up signal messages, or information on differentiated low-power wakeup signal messages from different sources. In some example embodiments, the method may further include transforming the low-power wake-up signal into a time domain with an inverse fast Fourier transform operation, and multiplexing the transformed low-power wake-up signal with a new radio signal into the orthogonal frequency division multiplexing symbol. In other example embodiments, the low-power wake-up signal and the new radio signal may have different subcarriers spacings. In further example embodiments, the predefined modulation may be on-off keying or frequency shift keying.

FIG. 7 illustrates a set of apparatuses 10 and 20 according to certain example embodiments. In certain example embodiments, apparatuses 10 and 20 may be elements in a communications network or associated with such a network. For example, apparatus 10 may be an LR (i.e., UE), and apparatus 20 may be a network (i.e., gNB).

In some example embodiments, apparatuses 10 and 20 may include one or more processors, one or more computer-readable storage medium (for example, memory, storage, or the like), one or more radio access components (for example, a modem, a transceiver, or the like), and/or a user interface. In some example embodiments, apparatuses 10 and 20 may be configured to operate using one or more radio access technologies, such as GSM, LTE, LTE-A, NR, 5G, WLAN, WiFi, NB-IoT, Bluetooth, NFC, MulteFire, and/or any other radio access technologies. It should be noted that one of ordinary skill in the art would understand that apparatuses 10 and 20 may include components or features not shown in FIG. 7.

As illustrated in the example of FIG. 7, apparatuses 10 and 20 may include or be coupled to a processors 12 and 22 for processing information and executing instructions or operations. Processors 12 and 22 may be any type of general or specific purpose processor. In fact, processors 12 and 22 may include one or more of general-purpose computers, special purpose computers, microprocessors, digital signal processors (DSPs), field-programmable gate arrays (FPGAs), application-specific integrated circuits (ASICs), and processors based on a multi-core processor architecture, as examples. While a single processors 12 and 22 is shown in FIG. 7, multiple processors may be utilized according to other example embodiments. For example, it should be understood that, in certain example embodiments, apparatuses 10 and 20 may include two or more processors that may form a multiprocessor system (e.g., in this case processors 12 may represent a multiprocessor) that may support multiprocessing. According to certain example embodiments, the multiprocessor system may be tightly coupled or loosely coupled (e.g., to form a computer cluster).

Processors 12 and 22 may perform functions associated with the operation of apparatuses 10 and 20 including, as some examples, precoding of antenna gain/phase parameters, encoding and decoding of individual bits forming a communication message, formatting of information, and overall control of the apparatuses 10 and 20, including processes and examples illustrated in FIGS. 1-6.

Apparatuses 10 and 20 may further include or be coupled to a memories 14 and 24 (internal or external), which may be respectively coupled to processors 12 and 24 for storing information and instructions that may be executed by processors 12 and 24. Memories 14 and 24 may be one or more memories and of any type suitable to the local application environment, and may be implemented using any suitable volatile or nonvolatile data storage technology such as a semiconductor-based memory device, a magnetic memory device and system, an optical memory device and system, fixed memory, and/or removable memory. For example, memories 14 and 24 can be comprised of any combination of random access memory (RAM), read only memory (ROM), static storage such as a magnetic or optical disk, hard disk drive (HDD), or any other type of non-transitory machine or computer readable media. The instructions stored in memories 14 and 24 may include program instructions or computer program code that, when executed by processors 12 and 22, enable the apparatuses 10 and 20 to perform tasks as described herein.

In certain example embodiments, apparatuses 10 and 20 may further include or be coupled to (internal or external) a drive or port that is configured to accept and read an external computer readable storage medium, such as an optical disc, USB drive, flash drive, or any other storage medium. For example, the external computer readable storage medium may store a computer program or software for execution by processors 12 and 22 and/or apparatuses 10 and 20 to perform any of the methods and examples illustrated in FIGS. 1-6.

In some example embodiments, apparatuses 10 and 20 may also include or be coupled to one or more antennas 15 and 25 for receiving a downlink signal and for transmitting via an UL from apparatuses 10 and 20. Apparatuses 10 and 20 may further include a transceivers 18 and 28 configured to transmit and receive information. The transceivers 18 and 28 may also include a radio interface (e.g., a modem) coupled to the antennas 15 and 25. The radio interface may correspond to a plurality of radio access technologies including one or more of GSM, LTE, LTE-A, 5G, NR, WLAN, NB-IoT, Bluetooth, BT-LE, NFC, RFID, UWB, and the like. The radio interface may include other components, such as filters, converters (for example, digital-to-analog converters and the like), symbol demappers, signal shaping components, an Inverse Fast Fourier Transform (IFFT) module, and the like, to process symbols, such as OFDMA symbols, carried by a downlink or an UL.

For instance, transceivers 18 and 28 may be configured to modulate information on to a carrier waveform for transmission by the antennas 15 and 25 and demodulate information received via the antenna 15 and 25 for further processing by other elements of apparatuses 10 and 20. In other example embodiments, transceivers 18 and 28 may be capable of transmitting and receiving signals or data directly. Additionally or alternatively, in some example embodiments, apparatus 10 may include an input and/or output device (I/O device). In certain example embodiments, apparatuses 10 and 20 may further include a user interface, such as a graphical user interface or touchscreen.

In certain example embodiments, memories 14 and 34 store software modules that provide functionality when executed by processors 12 and 22. The modules may include, for example, an operating system that provides operating system functionality for apparatuses 10 and 20. The memory may also store one or more functional modules, such as an application or program, to provide additional functionality for apparatuses 10 and 20. The components of apparatuses 10 and 20 may be implemented in hardware, or as any suitable combination of hardware and software. According to certain example embodiments, apparatuses 10 and 20 may optionally be configured to communicate each other (in any combination) via a wireless or wired communication links 70 according to any radio access technology, such as NR.

According to certain example embodiments, processors 12 and 22 and memories 14 and 24 may be included in or may form a part of processing circuitry or control circuitry. In addition, in some example embodiments, transceivers 18 and 28 may be included in or may form a part of transceiving circuitry.

For instance, in certain example embodiments, apparatus 10 may be controlled by memory 14 and processor 12 to receive an orthogonal frequency division multiplexing symbol of a low-power wake-up signal from a network element. Apparatus 10 may also be controlled by memory 14 and processor 12 to determine, based on the low-power wake-up signal, an amplitude threshold. Apparatus 10 may further be controlled by memory 14 and processor 12 to determine, based on the orthogonal frequency division multiplexing symbol of the low-power wake-up signal, a first part of information bits. In addition, apparatus 10 may be controlled by memory 14 and processor 12 to determine, based on the threshold, a location of a signal pulse of the low-power wake-up signal within the orthogonal frequency division multiplexing symbol. Further, apparatus 10 may be controlled by memory 14 and processor 12 to estimate a second part of information bits based on the location of the signal pulse.

In other example embodiments, apparatus 20 may be controlled by memory 24 and processor 22 to segment a payload of bits of a low-power wake-up signal into a plurality of sets. Apparatus 20 may also be controlled by memory 24 and processor 22 to encode a first set of the plurality of sets. Apparatus 20 may further be controlled by memory 24 and processor 22 to assign the encoded bits of the first set of the payload of bits to subcarriers with subcarrier spacing of the low-power wake-up signal. In addition, apparatus 20 may be controlled by memory 24 and processor 22 to apply phase ramp to the assigned subcarriers based on a second set of the plurality of sets.

In some example embodiments, an apparatus (e.g., apparatus 10 and/or apparatus 20) may include means for performing a method, a process, or any of the variants discussed herein. Examples of the means may include one or more processors, memory, controllers, transmitters, receivers, and/or computer program code for causing the performance of the operations.

Certain example embodiments may be directed to an apparatus that includes means for performing any of the methods described herein including, for example, means for receiving an orthogonal frequency division multiplexing symbol of a low-power wake-up signal from a network element. The apparatus may also include means for determining, based on the low-power wake-up signal, an amplitude threshold. The apparatus may further include means for determining, based on the orthogonal frequency division multiplexing symbol of the low-power wake-up signal, a first part of information bits. In addition, the apparatus may include means for determining, based on the threshold, a location of a signal pulse of the low-power wake-up signal within the orthogonal frequency division multiplexing symbol. Further, the apparatus may include means for estimating a second part of information bits based on the location of the signal pulse.

Additional example embodiments may be directed to an apparatus that includes means for performing any of the methods described herein including, for example, means for segmenting a payload of bits of a low-power wake-up signal into a plurality of sets. The apparatus may also include means for encoding a first set of the plurality of sets. The apparatus may further include means for assigning the encoded bits of the first set of the payload of bits to subcarriers with subcarrier spacing of the low-power wake-up signal. In addition, the apparatus may include means for applying phase ramp to the assigned subcarriers based on a second set of the plurality of sets.

Certain example embodiments described herein provide several technical effects. For instance, in some example embodiments, it may be possible to utilize two dimensions to encode raw bits to improve spectral efficiency without compromising performance. In other example embodiments, it may be possible to increase the overall information provided to the UEs by utilizing two dimensions. Additionally, some example embodiments may provide a 2D modulation scheme that uses either OOK or FSK based modulation schemes together with PPM-based encoding to provide additional information to the UEs. Furthermore, the modulation schemes of certain example embodiments may be applied to the LP-WUS payload.

A computer program product may include one or more computer-executable components which, when the program is run, are configured to carry out some example embodiments. The one or more computer-executable components may be at least one software code or portions of it. Modifications and configurations required for implementing functionality of certain example embodiments may be performed as routine(s), which may be implemented as added or updated software routine(s). Software routine(s) may be downloaded into the apparatus.

As an example, software or a computer program code or portions of it may be in a source code form, object code form, or in some intermediate form, and it may be stored in some sort of carrier, distribution medium, or computer readable medium, which may be any entity or device capable of carrying the program. Such carriers may include a record medium, computer memory, read-only memory, photoelectrical and/or electrical carrier signal, telecommunications signal, and software distribution package, for example. Depending on the processing power needed, the computer program may be executed in a single electronic digital computer or it may be distributed amongst a number of computers. The computer readable medium or computer readable storage medium may be a non-transitory medium.

In other example embodiments, the functionality may be performed by hardware or circuitry included in an apparatus (e.g., apparatus 10 or apparatus 20), for example through the use of an application specific integrated circuit (ASIC), a programmable gate array (PGA), a field programmable gate array (FPGA), or any other combination of hardware and software. In yet another example embodiment, the functionality may be implemented as a signal, a non-tangible means that can be carried by an electromagnetic signal downloaded from the Internet or other network.

According to certain example embodiments, an apparatus, such as a node, device, or a corresponding component, may be configured as circuitry, a computer or a microprocessor, such as single-chip computer element, or as a chipset, including at least a memory for providing storage capacity used for arithmetic operation and an operation processor for executing the arithmetic operation.

One having ordinary skill in the art will readily understand that the disclosure as discussed above may be practiced with procedures in a different order, and/or with hardware elements in configurations which are different than those which are disclosed. Therefore, although the disclosure has been described based upon these example embodiments, it would be apparent to those of skill in the art that certain modifications, variations, and alternative constructions would be apparent, while remaining within the spirit and scope of example embodiments. Although the above embodiments refer to 5G NR and LTE technology, the above embodiments may also apply to any other present or future 3GPP technology, such as LTE-advanced, and/or fourth generation (4G) technology.

### Partial Glossary

3GPP 3^{rd} Generation Partnership Project
5G 5th Generation
5GCN 5G Core Network
5GS 5G System
BS Base Station
CP Cyclic Prefix
DFT Discrete Fourier Transformation
DL Downlink
EIRP Effective Isotropic Radiated Power
eNB Enhanced Node B
E-UTRAN Evolved UTRAN
gNB 5G or Next Generation NodeB
LP Low Power
LR Low-Power Wake-up Radio
LTE Long Term Evolution
NCR Network-Controlled Repeaters
NR New Radio
NW Network
OFDM Orthogonal Frequency-Division Multiplexing
OOK On-Off Keying
PPM Pulse Position Modulation
RF Radio Frequency
RRM Radio Resource Management
SCS Subcarrier Spacing
UE User Equipment
UL Uplink
WUS Wake-up Signal

1-41. (canceled)

42. A method, comprising:
receiving an orthogonal frequency division multiplexing symbol of a low-power wake-up signal from a network element;
determining, based on the low-power wake-up signal, an amplitude threshold;
determining, based on the orthogonal frequency division multiplexing symbol of the low-power wake-up signal, a first part of information bits;
determining, based on the threshold, a location of a signal pulse of the low-power wake-up signal within the orthogonal frequency division multiplexing symbol; and
estimating a second part of information bits based on the location of the signal pulse.

43. The method according to claim 42, further comprising:
performing synchronization with the network element in order to perform on-off keying or frequency shift keying, and pulse position modulation detection.

44. The method according to claim 42, wherein the signal pulse is a low-power wake-up signal pulse.

45. The method according to claim 42, wherein the low-power wake-up signal is received at a frequency location in a spectrum that is constant across all symbols.

46. The method according to claim 42, wherein the signal pulse comprises a width in a time domain that varies based on a bandwidth of the low-power wake-up signal transmission.

47. A method, comprising:
segmenting a payload of bits of a low-power wake-up signal into a plurality of sets;
encoding a first set of the plurality of sets;
assigning the encoded bits of the first set of the payload of bits to subcarriers with subcarrier spacing of the low-power wake-up signal; and
applying phase ramp to the assigned subcarriers based on a second set of the plurality of sets.

48. The method according to claim 47, wherein the first set of the plurality of sets is carried by a predefined modulation, and a second set of the plurality of sets is carried by a pulse position modulation.

49. An apparatus, comprising:
at least one processor; and
at least one memory storing instructions that,
when executed by the at least one processor, cause the apparatus at least to:
receive an orthogonal frequency division multiplexing symbol of a low-power wake-up signal from a network element;
determine, based on the low-power wake-up signal, an amplitude threshold;
determine, based on the orthogonal frequency division multiplexing symbol of the low-power wake-up signal, a first part of information bits;
determine, based on the threshold, a location of a signal pulse of the low-power wake-up signal within the orthogonal frequency division multiplexing symbol; and
estimate a second part of information bits based on the location of the signal pulse.

50. The apparatus according to claim 49, wherein the apparatus is further caused to:
perform synchronization with the network element in order to perform on-off keying or frequency shift keying, and pulse position modulation detection.

51. The apparatus according to claim 49, wherein the signal pulse is a low-power wake-up signal pulse.

52. The apparatus according to claim 49, wherein the low-power wake-up signal is received at a frequency location in a spectrum that is constant across all symbols.

53. The apparatus according to claim 49, wherein the signal pulse comprises a width in a time domain that varies based on a bandwidth of the low-power wake-up signal transmission.

54. An apparatus, comprising:
at least one processor; and
at least one memory storing instructions that,
when executed by the at least one processor, cause the apparatus at least to:
segment a payload of bits of a low-power wake-up signal into a plurality of sets;
encode a first set of the plurality of sets;
assign the encoded bits of the first set of the payload of bits to subcarriers with subcarrier spacing of the low-power wake-up signal; and
apply phase ramp to the assigned subcarriers based on a second set of the plurality of sets.

55. The apparatus according to claim 54, wherein the first set of the plurality of sets is carried by a predefined modulation, and a second set of the plurality of sets is carried by a pulse position modulation.

56. The apparatus according to claim 54, wherein the apparatus is further caused to:
place the low-power wake-up signal in a desired frequency location of the orthogonal frequency division multiplexing symbol.

57. The apparatus according to claim 54, wherein the apparatus is further caused to:
filter the low-power wake-up signal.

58. The apparatus according to claim 54, wherein the orthogonal frequency division multiplexing symbol carries information comprising at least one of the following:
identification of a wake-up signal entity,
information on further segmentation between user equipment groups,
information for a target paging occasion to be monitored, or for a user equipment procedure related to a low-power wake-up signal triggered action,
information enabling differentiation of low-power wake-up signal messages, or
information on differentiated low-power wakeup signal messages from different sources.

59. The apparatus according to claim 54, wherein the apparatus is further caused to:
transform the low-power wake-up signal into a time domain with an inverse fast Fourier transform operation; and
multiplex the transformed low-power wake-up signal with a new radio signal into the orthogonal frequency division multiplexing symbol.

60. The apparatus according to claim 59, wherein the low-power wake-up signal and the new radio signal have different subcarriers spacings.

61. The apparatus according to claim 55, wherein the predefined modulation is on-off keying or frequency shift keying.
